(19) United States
(12) Patent Application Publication
(10) Pub. No.: US 2008/0273282 A1
(43) Pub. Date: Nov. 6, 2008

(54) DBD PLASMA DISCHARGED STATIC ELIMINATOR

(76) Inventor: Makoto Takayanagi, Hamamatsu -city (JP)

Correspondence Address: Leighton K. Chong, 133 Kaai Street, Honolulu, HI, 96821, US

(21) Appl. No.: 12/104,368

(22) Filed: Apr. 16, 2008

(30) Foreign Application Priority Data
Mar. 2, 2006 (JP) 2006-055714
May 1, 2007 (JP) 2007-120446

(51) Int. Cl. H05F 3/06

(52) U.S. Cl. 361/213

(57) ABSTRACT

A plasma discharged static eliminator comprises a plasma discharging electrode body for generating plasma as a source of ions. The plasma discharging electrode body includes two electrodes between which alternate voltage is applied, and a dielectric covering the electrodes. The plasma discharged static eliminator further comprises an inner grid electrode disposed around the plasma discharging electrode body, and an outer grid electrode disposed outside of the inner grid electrode.

### TECHNICAL FIELD

This invention generally relates to a static eliminator in which plasma is used as a source of ions, and more particularly, to a plasma discharged static eliminator, using dielectric barrier discharge, hereinafter referred to as DBD.

### BACKGROUND OF INVENTION

An earlier Japanese patent application No. 2006-055714 filed on Mar. 2, 2006 by the same applicant discloses the DBD plasma discharged static eliminator in which plasma is used as a source of ions.

Although according to the disclosed invention the object which is located near the static eliminator can be statically eliminated since charged particles exist near the plasma, in order to eliminate a faraway object, the charged particles has to be retrieved from the plasma and transferred to the object, using fan blow or compressed air.

However, although static charge can be retrieved by fan blow or compressed air, the problem in that dust is blown up and flaws due to dust are promoted arises since wind occurs around. For this reason a new method in which charged particles are flied away without using fan blow or compressed air has been requested.

Therefore, it is an object of the present invention to provide a DBD plasma discharged static eliminator in which the charged particles generated by plasma can be transferred far away without using external force such as fan blow or compressed air.

### SUMMARY OF INVENTION

To accomplish the object, there is provided a plasma discharged static eliminator which comprises at least one plasma discharging electrode body for generating plasma as a source of ions including at least two electrodes between which alternate voltage is applied, and a dielectric covering said electrodes, at least one inner grid electrode disposed around said plasma discharging electrode body, and at least one outer grid electrode disposed outside of said inner grid electrode.

Other objects, features, and advantages of the present invention will be explained in the following detailed description of the invention having reference to the appended drawings:

### BRIEF DESCRIPTION OF DRAWINGS

FIG. 1 shows a first embodiment of static eliminator according to the present invention, FIG. 1a is its plan view, FIG. 1b is its front view, FIG. 1c is its cross sectional view taken along line A-A of FIG. 1a, FIG. 1d is a diagrammatic view showing a power supply system, and FIG. 1e is a side view showing plasma discharging electrode body of static eliminator,

FIG. 2 shows a second embodiment of static eliminator according to the present invention, FIG. 2a is a diagrammatic plan view showing a static eliminator as a whole, and FIG. 2b is a list showing the relations among polarities of voltage applied to an inner grid and an outer grid, directions of electric fields between the inner grid and outer grid, and polarities of emitted charged particles,

FIG. 3 shows relations between electric field and force received from electric field, FIG. 3a shows the case of plus charged particles, and FIG. 3b shows the case of minus charged particles,

FIG. 4 shows a third embodiment of static eliminator according to the present invention,

FIG. 5 shows a fourth embodiment of static eliminator according to the present invention,

FIG. 6 shows a fifth embodiment of static eliminator according to the present invention, FIG. 6a is a diagrammatic plan view of the static eliminator, and FIG. 6b is a list showing polarities of voltage applied to two inner grids and two outer grids,

FIG. 7 shows a sixth embodiment of static eliminator according to the present invention, FIG. 7a is a diagrammatic plan view of the static eliminator and FIG. 7b is a list showing polarities of voltages applied to inner grids, outer grids and reflective electrodes,

FIG. 8 shows a seventh embodiment of static eliminator according to the present invention,

FIG. 9 shows an eighth embodiment of static eliminator according to the present invention, FIG. 9a is its diagrammatic plan view, FIG. 9b is a cross sectional view taken along line A-A of FIG. 9a, and FIG. 9c shows a heater driving circuit, and

FIG. 10 shows a ninth embodiment of static eliminator according to the present invention, FIG. 10a is its diagrammatic plan view, FIG. 10b is a cross sectional view taken along line A-A of FIG. 10a, and FIG. 10c shows a heater driving circuit.

### DETAILED DESCRIPTION OF THE INVENTION

### First Embodiment

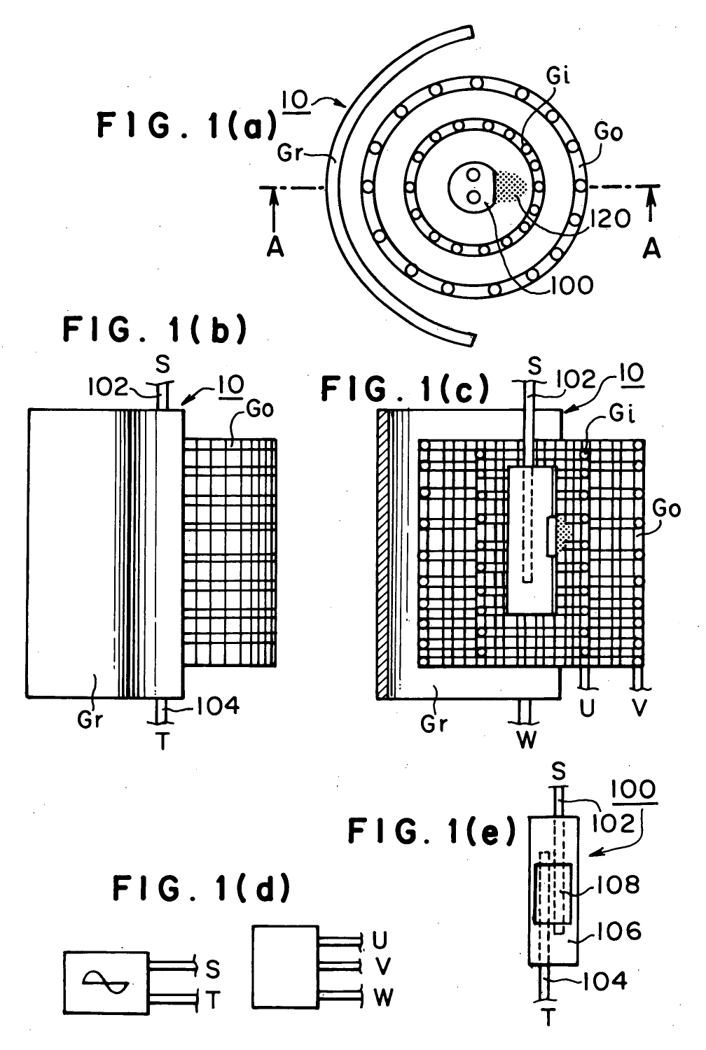

FIG. 1 shows a first embodiment of static eliminator according to the present invention, FIG. 1a is its plan view, FIG. 1b is its front view, FIG. 1c is its cross sectional view taken along line A-A of FIG. 1a, FIG. 1d is a diagrammatic view showing a power supply system, and FIG. 1e is a side view showing plasma discharging electrode body of static eliminator.

To start with, a plasma discharging electrode body which generates plasma, that is, charged particles 120 will be explained. As shown in FIG. 1a, a plasma discharging electrode body 100 is disposed in the center of a static eliminator 10. As shown in FIG. 1e, for example, the plasma discharging electrode body 100 comprises two electrodes 102 and 104 made of conductors juxtaposed in parallel and a dielectric 106 covering these conductors. The dielectric 106 is formed with a recessed area 108 which makes on the dielectric a thin portion for facilitating generation of plasma. However this recessed area is not indispensable.

The other example of plasma discharging electrode body 100 is described in detail in the earlier patent application No. 2006-055714. For example, electrodes 102 and 104 are disposed on a line in stead of juxtaposition so that their leading ends are opposed to each other. The recessed area may take various configurations. For details, the patent application No. 2006-055714 may be made reference to.

As shown in FIGS. 1a to 1c, a double grid electrode structure made of mesh electrodes is disposed outside of plasma discharging electrode body 100. That is, an inner grid electrode Gi in the form of circular mesh configuration, hereinafter referred to as inner grid, is disposed first outside of the plasma discharging electrode body 100, and further outside thereof an outer grid electrode Go in the form of circular mesh configuration, hereinafter referred to as outer grid, is disposed. Further outside thereof, a reflection electrode Gr made of conductive mesh or plate in the form of parabola in section is disposed partially.

The plasma or charged particles 120 is generated near the recessed area of the dielectric 106 of plasma discharging electrode body 100, and the charged particles thus generated diffuses and passes through the inner grid Gi. Thereafter the particles are accelerated by the electric field between the inner grid Gi and the outer grid Go and then emitted outwardly. In the meanwhile the charged particles heading for reflection grid Gr are reflected by the reflection grid Gr and emitted outwardly. The polarities of emitted particles becomes plus or minus in accordance with the polarities of voltages applied to the inner grid Gi, the outer grid Go and the reflection grid Gr.

As shown in FIGS. 1b to 1d, an AC voltage S and T are respectively applied to electrodes 102 and 104 of the plasma discharging electrode body 100 from an AC power supply, and voltages U, V and W are respectively applied to the inner grid Gi, the outer grid Go and the reflection grid Gr from another power supply. The natures or polarities of voltages applied to the inner grid Gi, the outer grid Go and the reflection grid Gr will be explained in the later embodiments.

### Second Embodiment

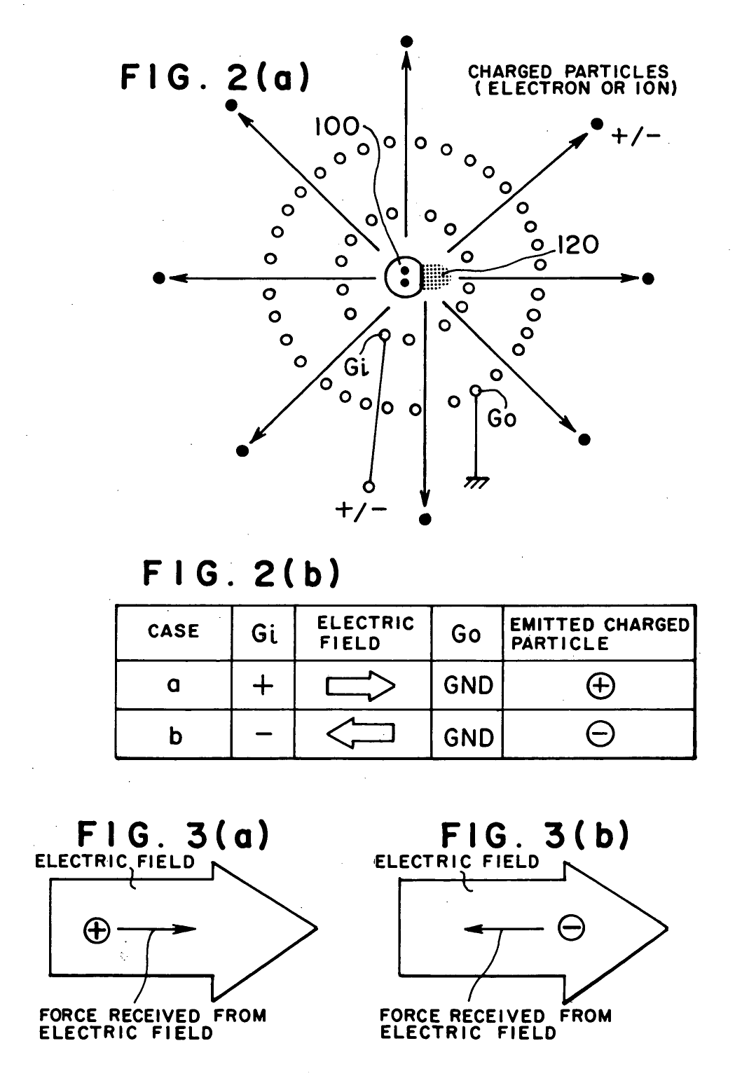

FIG. 2 shows a second embodiment of static eliminator according to the present invention, FIG. 2a is a diagrammatic plan view showing a static eliminator as a whole, and FIG. 2b is a list showing the relations among polarities of voltage applied to an inner grid and an outer grid, directions of electric fields between the inner grid and outer grid, and polarities of emitted charged particles.

As shown in FIG. 2a, a double mesh electrode structure comprising grid electrodes Gi and Go is provided around a source of charged particles or ions of plasma generated from the plasma discharging electrode body 100 and voltages are applied to the grid electrodes to generate electric field. At that time, as shown in FIG. 2b, when the outer grid Go is grounded and plus voltage is applied to the inner grid Gi, electric flux line is outwardly directed to the outer grid Go from the inner grid Gi. On the other hand, when minus voltage is applied to the inner grid Gi, electric flux line is inwardly directed to the inner grid Gi from the outer grid Go.

Now referring to FIG. 3, FIG. 3 shows relations between electric field and force received from electric field, FIG. 3a shows the case of plus charged particles, and FIG. 3b shows the case of minus charged particles. As shown in FIG. 3a, plus charged particles are received with the force in the direction of electric field or electric flux line. In the meanwhile, as shown in FIG. 3b, minus charged particles are received with the force in the direction opposite to that of electric field or electric flux line.

That function will be explained with reference to FIG. 2. As shown in FIG. 2b, in case that the outer grid Go is grounded and the control voltage of the inner grid Gi is plus, the electric field is directed outwardly and the emitted charged particles are plus. On the other hand, in case that the outer grid Go is grounded and the control voltage of the inner grid Gi is minus, the electric field is directed inwardly and the emitted charged particles are minus. In other words, the charged particles polarity of which is the same as that of control voltage applied to the inner grid are emitted.

### Third Embodiment

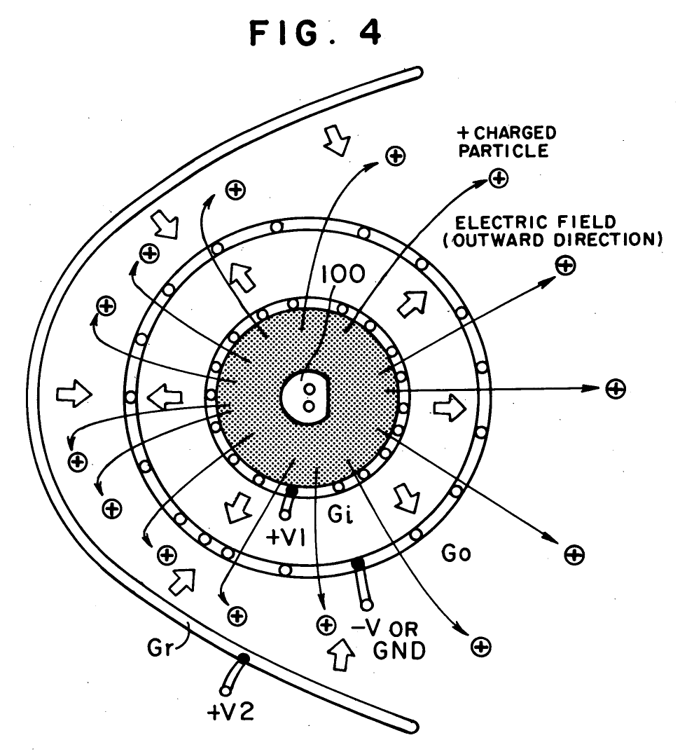

FIG. 4 shows a third embodiment of static eliminator according to the present invention. A reflection grid Gr is provided outside of the inner grid Gi and the outer grid Go. For example, minus voltage −V is applied to the outer grid Go or the outer grid Go is grounded, and plus voltage +V1 is applied to the inner grid Gi. On the left side in the drawing, the reflection grid Gr to which plus voltage +V2 is applied is provided outside of these grids Gi and Go. In this case, plus charged particles in the direction to the right are directly emitted outwardly while plus particles in the direction to the left is reflected by the reflection grid Gr and then emitted rightward.

### 4th Embodiment

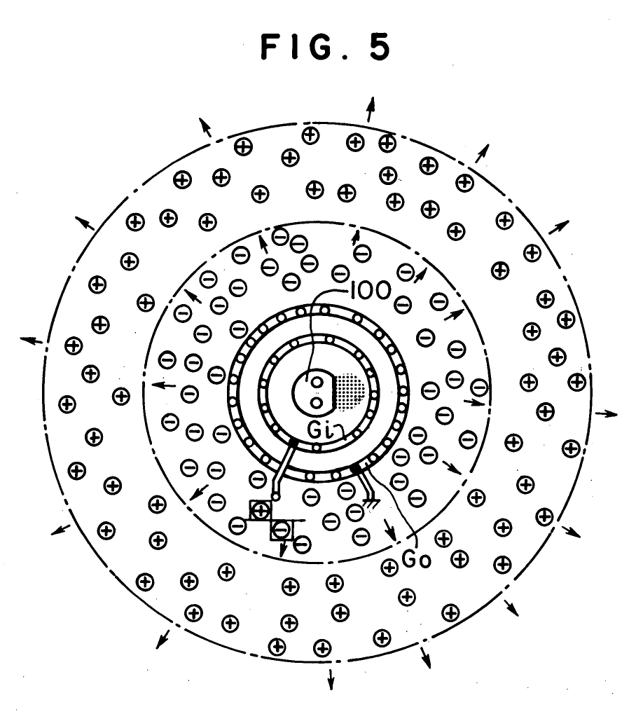

FIG. 5 shows a fourth embodiment of static eliminator according to the present invention. When the outer grid Go is grounded and plus and minus voltages are alternately applied to the inner grid Gi, plus and minus charged particles are alternately emitted on the time base. With the conventional corona discharged static eliminator using discharging needles, since the high voltage power supply is switched between plus and minus, it takes a long time to neutralize electric charge at the switching time, and thus a high speed switching cannot be made. As a result, the frequency of switching was limited to 33 Hz at most. That is, since only a low speed operation can be made, plus and minus ions or charged particles are not mixed enough and thus there was the problem in that microseism of ion balance occurred. On the other hand, with the system according to the present invention in which the grid voltage is switched over, the voltage is low and a high speed operation can be easily achieved without accumulation of electric charge. As a result a landslide high speed operation can be achieved and at the same time, the problem of microseism of ion balance can be solved.

### 5th Embodiment

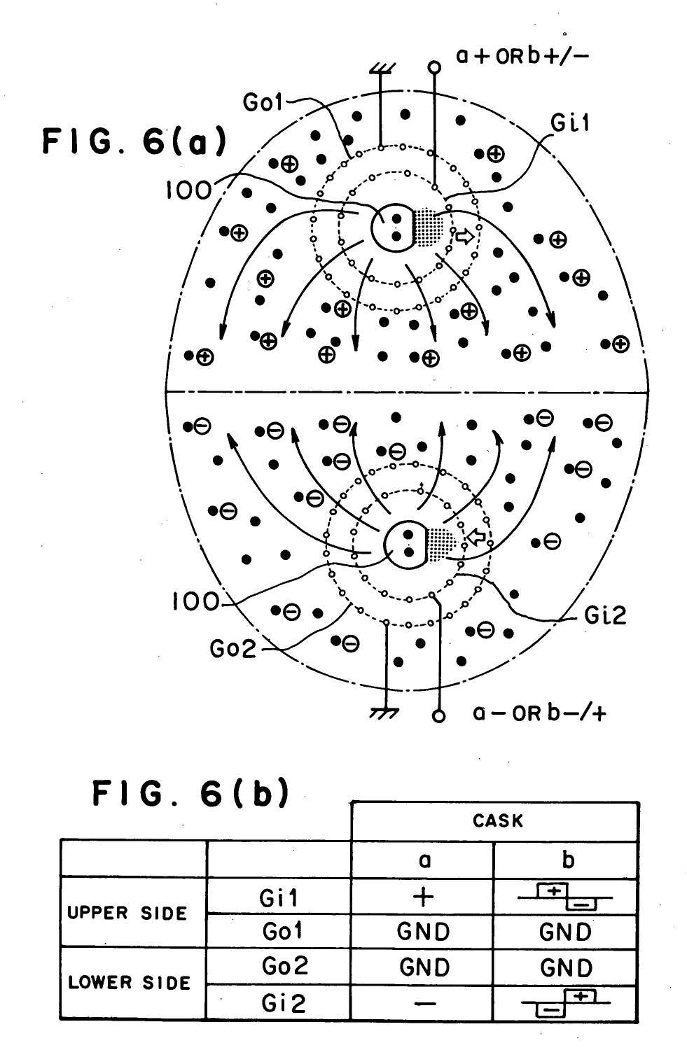

FIG. 6 shows a fifth embodiment of static eliminator according to the present invention, FIG. 6a is a diagrammatic plan view of the static eliminator, and FIG. 6b is a list showing polarities of voltages applied to two inner grids and two outer grids. This is an example of a calm static eliminator having no reflection grid. The static eliminator has two, that is, an upper and lower charged particle emitting portions each of which has a combination of a plasma discharging electrode body, an inner grid and an outer grid. In the case a of FIG. 6b, the outer grids Go1 and Go2 are grounded and opposite polarities of voltages are given to the inner grids Gi1 and Gi2. As a result, one of charged particle emitting portions emits plus charged particles while the other emits minus charged particles.

On the other hand, in the case b, the outer grids Go1 and Go2 are grounded and the voltages applied to the inner grids Gi1 and Gi2 are varied in a pulsed fashion while opposite polarities of voltages are given to the inner grids Gi1 and Gi2. each other. As a result the polarities of the emitted charged particles can be alternately changed to plus and minus having opposite polarity each other to enhance the mixture of charged particles or ions easily. The area surrounded by dashed line is effective in static elimination.

### 6th Embodiment

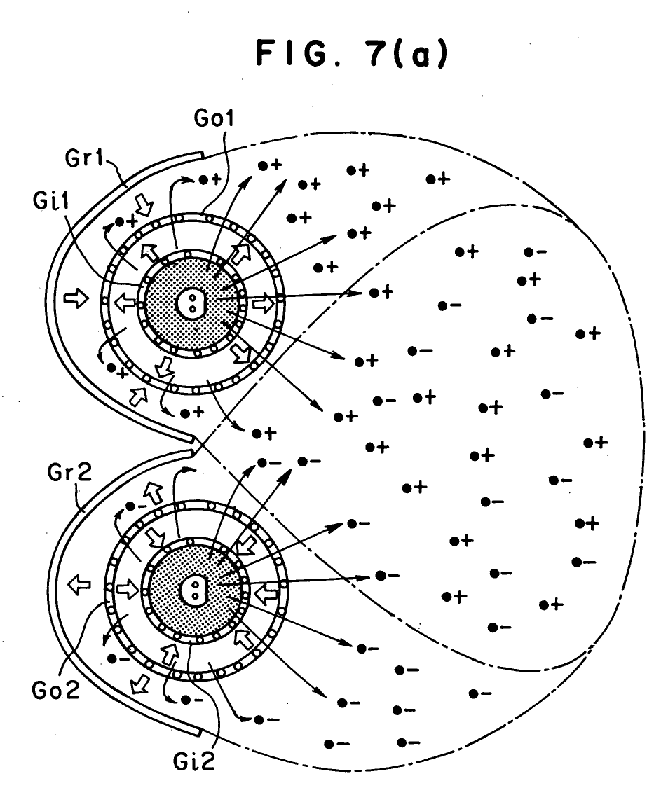

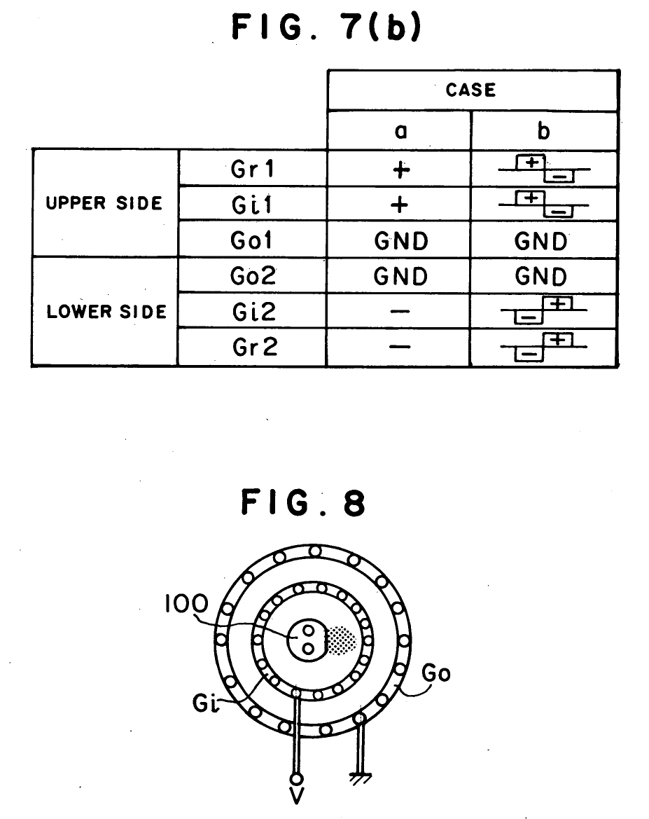

FIG. 7 shows a sixth embodiment of static eliminator according to the present invention, FIG. 7a is a diagrammatic plan view of the static eliminator and FIG. 7b is a list showing polarities of voltages applied to inner grids, outer grids and reflective electrodes. This is another example of a calm static eliminator having reflection grids. The static eliminator has two, that is, an upper and lower charged particle emitting portions each of which has a combination of a plasma discharging electrode body, an inner grid, an outer grid and a reflection grid. In the case a of FIG. 7b, the outer grids Go1 and Go2 are grounded and opposite polarities of voltages are given to the inner grids Gi1 and Gi2 each other. As a result, one of charged particle emitting portions emits plus charged particles while the other emits minus charged particles.

Furthermore, reflection electrodes Gr1 and Gr2 are provided at the rear of plasma ion sources or charged particle sources and the voltages of the same polarity as that of the inner grid are applied to the reflection electrodes Gr1 and Gr2 respectively. the emitting direction of the charged particles can be orientated to one side. On the other hand, in the case b, of FIG. 7b when the voltages applied to the inner grids Gi1 and Gi2 are varied in a pulsed fashion the polarities of the emitted charged particles can be alternately changed to plus and minus having opposite polarity each other to enhance the mixture of charged particles or ions easily. The area surrounded by dashed line is effective in static elimination.

### 7th Embodiment

FIG. 8 shows a seventh embodiment of static eliminator according to the present invention. When the outer grid Go is grounded and the control voltage is applied to the inner grid Gi, the charged particles are emitted in accordance with the control voltage. In this case, since the outer grid Go is grounded, the outside leakage of the electric field generated by the voltage applied to the inner grid Gi can be prevented. In the case that the object to be static eliminated is a semiconductor having a weakness for electrostatic field, the electrostatic discharge damage thereof can be prevented.

### 8th Embodiment

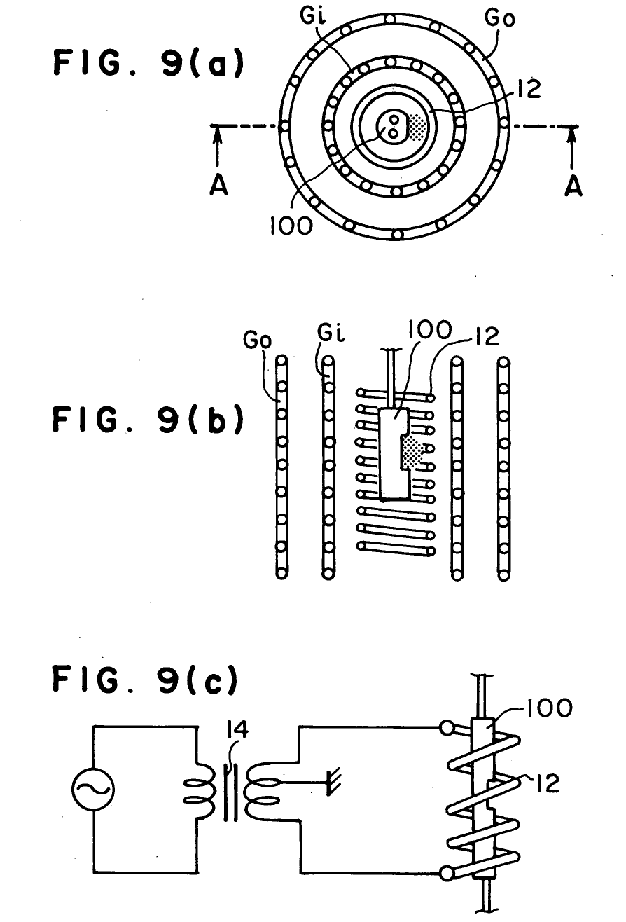

FIG. 9 shows an eighth embodiment of static eliminator according to the present invention, FIG. 9a is its diagrammatic plan view, FIG. 9b is a cross sectional view taken along line A-A of FIG. 9a, and FIG. 9c shows a heater driving circuit. A heater 12 is provided outside of the plasma discharging electrode body 100 and within the inner grid Gi. In order to dissolve ozone resulting from generation of plasma to detoxify it, the plasma is heated more than 80 degrees in centigrade by the heater 12. When the ozone is heated more than 80 degrees in centigrade, the ozone is dissolved into oxygen since the ozone is an unstable material. At the time, if the heater has a potential the potential has an effect on the plasma. Therefore it is preferable that the middle point of the secondary winding or heater side of transformer 14 is grounded.

### 9th Embodiment

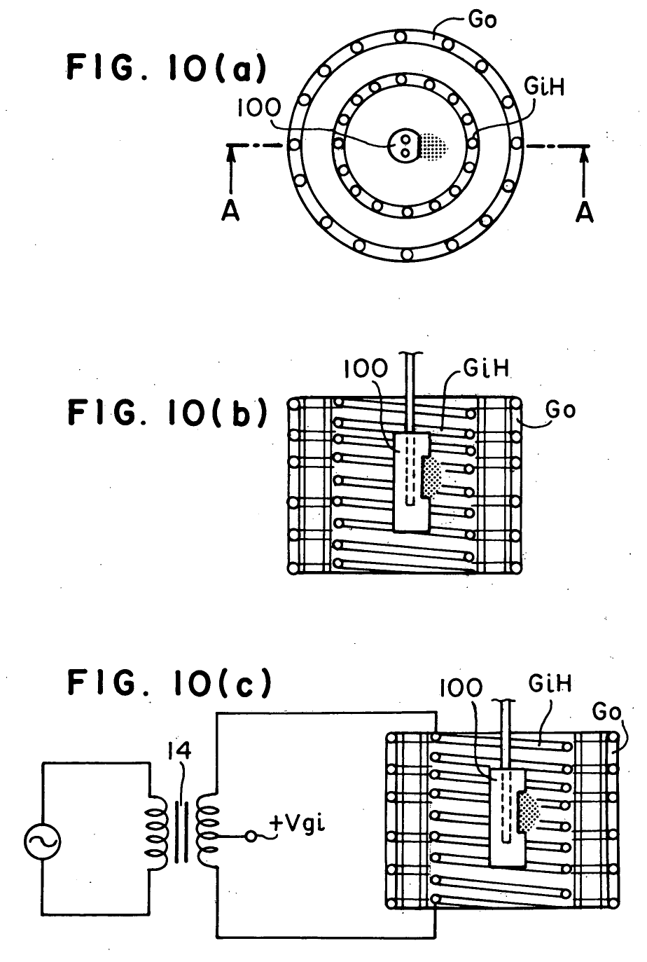

FIG. 10 shows a ninth embodiment of static eliminator according to the present invention, FIG. 10a is its diagrammatic plan view, FIG. 10b is a cross sectional view taken along line A-A of FIG. 10a, and FIG. 10c shows a heater driving circuit. With the embodiment, the function of dissolving the ozone into oxygen is the same as that of the 8th embodiment. However, an inner grid and heater GiH working both as inner grid and heater is used, differently from the previous embodiment. Therefore, the inner grid and heater GiH comprises a heating element. When the voltage +Vgi is applied to the inner grid and heater GiH, it is preferable that the voltage is applied to the middle point of the secondary winding or heater side of transformer 14.

It is understood that many modifications and variations may be devised given the above description of the principles of the invention. It is intended that all such modifications and variations be considered as within the spirit and scope of this invention, as it is defined in the following claims.

1. A plasma discharged static eliminator which comprises
at least one plasma discharging electrode body for generating plasma as a source of ions including at least two electrodes between which alternate voltage is applied, and a dielectric covering said electrodes,
at least one inner grid electrode disposed around said plasma discharging electrode body, and
at least one outer grid electrode disposed outside of said inner grid electrode.

2. A plasma discharged static eliminator according to claim 1 in which an adjustable voltage is applied between said inner grid electrode and said outer grid electrode to control the strength of electric field.

3. A plasma discharged static eliminator according to claim 2 in which outward or inward electric field is generated between said inner grid electrode and said outer grid electrode.

4. A plasma discharged static eliminator according to claim 2 in which outward and inward electric fields are alternately generated between said inner grid electrode and said outer grid electrode.

5. A plasma discharged static eliminator according to claim 1 which further comprises a reflection electrode disposed outside of said outer grid electrode.

6. A plasma discharged static eliminator according to claim 5 in which the voltage of the same polarity is applied to said reflection electrode and said inner grid electrode.

7. A plasma discharged static eliminator according to claim 5 in which said reflection electrode is disposed relative to said plasma discharging electrode body in a direction opposite to the direction in which ions are emitted.

8. A plasma discharged static eliminator according to claim 1 in which one plasma discharging electrode body comprising a source of ions for emitting plus ions and the other plasma discharging electrode body comprising a source of ions for emitting minus ions are juxtaposed.

9. A plasma discharged static eliminator according to claim 1 in which said outer grid electrode is grounded.

10. A plasma discharged static eliminator according to claim 1 in which a heater is provided outside of said plasma discharging electrode body.

11. A plasma discharged static eliminator according to claim 1 in which said inner grid electrode is constructed as a heater.
